(19) United States
(12) Patent Application Publication
(10) Pub. No.: US 2022/0080666 A1
(43) Pub. Date: Mar. 17, 2022

(54) COOLING PROCESS FOR THREE-DIMENSIONAL PRINTING SYSTEM

(71) Applicant: HEWLETT-PACKARD DEVELOPMENT COMPANY, L.P., SPRING, TX (US)

(72) Inventors: Jordi Bautista Ballester, Sant Cugat del Valles (ES); Pablo Dominguez Pastor, Sant Cugat del Valles (ES); Adrien Chiron, Sant Cugat del Valles (ES)

(73) Assignee: HEWLETT-PACKARD DEVELOPMENT COMPANY, L.P., SPRING, TX (US)

(21) Appl. No.: 17/420,503

(22) PCT Filed: May 30, 2019
(86) PCT No.: PCT/US2019/034537

§ 371 Date: Jul. 2, 2021

(51) Int. Cl. B29C 64/364; B29C 64/165; B29C 64/393; B33Y 10/00; B33Y 30/00; B33Y 40/20; B33Y 50/02

(52) U.S. Cl. CPC B29C 64/364; B29C 64/165; B29C 64/393; B33Y 50/02; B33Y 30/00; B33Y 40/20; B33Y 10/00

(57) ABSTRACT

A three-dimensional printing system comprises a build unit, a three-dimensional printer and a controller. The build unit comprising a build chamber and a heater. The printer is configured to generate a build volume comprising a three-dimensional object within the build chamber and the heater is configured to heat the build chamber. The controller is configured to control the heater to heat the build chamber for a predetermined time period after the build volume is generated, to allow the object to crystallise.

### BACKGROUND

A three-dimensional printer may generate a three-dimensional object by printing a plurality of successive two-dimensional layers on top of one another. In some three-dimensional printing systems, each layer of an object may be formed by placing a uniform layer of build material on the printer's build bed and then placing an agent at specific points at which it is desired to solidify the build material to form the layer of the object. Heat is then applied to the layer of build material, and the portions of the build material to which the printing agent has been applied heat above the melting temperature of the build material, causing those portions of the build material to coalesce. The result is a build volume comprising the generated object within residual build material that has not coalesced.

The build volume may then undergo a manual or automatic cleaning process to remove the non-coalesced build material, leaving the generated three-dimensional object.

### BRIEF DESCRIPTION OF THE DRAWINGS

FIG. 1 is an illustration of an example three-dimensional printing system;

FIG. 2 is an illustration of an example build unit;

FIG. 3 is an illustration of an example printer;

FIG. 4 is an illustration of a graphical representation of results of a differential scanning calorimetry experiment of a build material;

FIG. 5 is a flow chart of an example method; and

FIG. 6 is a block diagram of an example of a machine readable medium in association with a processor.

### DETAILED DESCRIPTION

In an example three-dimensional printing method, a fusing agent may be distributed over a layer of build material in a predetermined pattern, and heat may be applied to the layer of build material such that portions of the layer on which fusing agent is applied heat up, coalesce, and then solidify upon cooling, thereby forming a layer of the object. Portions of the layer of build material on which no fusing agent is applied do not heat sufficiently to coalesce and then solidify on cooling. This process is repeated over multiple layers to provide a build volume, wherein the build volume comprises the generated object within a volume of unfused build material.

The build volume may undergo a cleaning process, to provide the generated object with the portions of the unfused build material removed from the build volume. The cleaning process, also known as an unpacking process, for removing the unfused build material may be carried out manually, with care being taken to prevent breakage of the printed parts. Parts may be particularly prone to breakage if they are not fully crystallised when the cleaning process is carried out.

When some example build materials are used, the unfused build material may form a cake around the generated object, when the temperature of the build material is cooled below a caking temperature. The cake may be formed because the unfused build material has been heated and compacted. If a cake is formed around the generated object, it may not be possible to unpack the object.

Examples described herein may enable an operator to safely unpack a generated object by ensuring that a predetermined proportion of the three-dimensional object has been crystallised before unpacking, whilst avoiding cake formation.

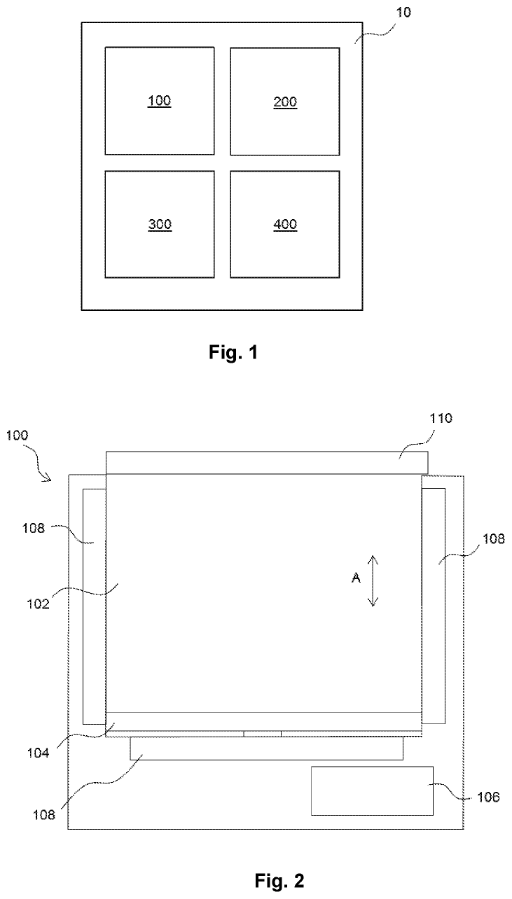

FIG. 1 shows a block diagram of a three-dimensional printing system 10. The system may comprise a build unit 100, a three-dimensional printer 200, and a processing station 300.

As shown in FIG. 2, the build unit 100 may comprise a build chamber 102 in which a three-dimensional object may be generated. A platform 104 may be provided in the build chamber 102, on which build volume comprising the three-dimensional object may be generated. The build unit 100 may comprise a build material storage 106 for storing build material and a build material supply unit (not shown) for providing build material to the platform. The platform may be movable in a substantially vertical direction within the build chamber 102, as indicated by arrow A.

The build unit 100 may comprise a plurality of heaters 108. The heaters may be applied at various surfaces of the build unit. For example, a heater 108 may be provided at each of a bottom surface and side walls of the build unit. The build unit 100 may comprise a lamp heater 110 that may be provided above a top surface of the build volume.

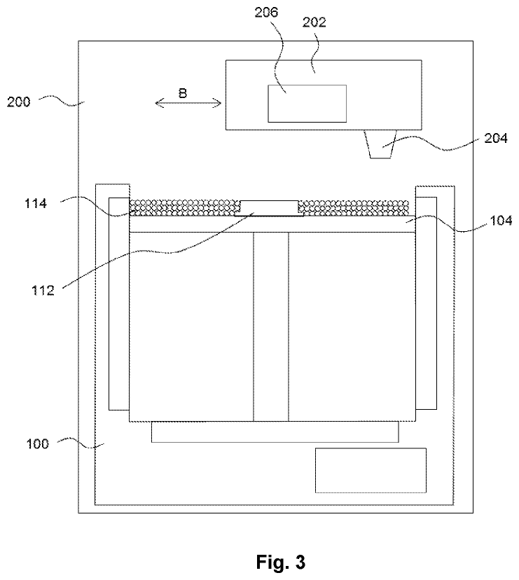

The build unit 100 may be provided within the printer 200, as shown in FIG. 3. In some examples, the build unit 100 may be removable from the printer 200, and may be movable into the processing station 300.

The printer 200 may comprise a carriage 202 that may be provided above the print build unit 100, and may be configured to move over the print bed in a direction indicated by arrow B. The carriage 202 may comprise a printing agent distributor 204, configured to provide a printing agent to the print bed. In an example, the printing agent may be a fusing agent. The printing agent distributor 204 may be a print head, for example a thermal or piezo print head. The print head may comprise a nozzle, for example an array of nozzles. The carriage may comprise a heat source 206 configured to apply heat over the print bed. The heat source may be a lamp, for example a fusing lamp, an infrared lamp or a microwave lamp.

The printer 200 may comprise a layer forming unit (not shown), which may form a uniform layer of the build material that is supplied by the build material supply unit. In an example, in use, the layer forming unit may form a uniform layer of build material on the build platform 104. The carriage 202 may move over the print bed, and the printing agent distributor 204 may deposit fusing agent to portions of the build material. The heat source 206 may heat up the upper layer of the print bed such that portions of the powder to which fusing agent has been deposited heat up above the melting temperature and coalesce. A layer may thereby be formed comprising a coalesced portion of the three-dimensional object and portions on unfused build material. The platform 104 may then be moved downwards so that a new layer of build material may be provided over the printed layer. A plurality of layers may be generated in this way, and the result may be a build volume comprising the three-dimensional object 112 within unfused build material 114.

The build material may be a powder. In some examples, the build material may be formed of, or may include, short fibres that may, for example, have been cut into short lengths from long strands or threads of the material. The build material may comprise plastics powders or powder-like material.

The build material may be a powder or powder-like elastomeric material, for example a thermoplastic polyurethane. Using an elastomeric material as the build material may provide the generated object with elastic properties. Elastomeric build materials may form cake when cooled below the caking temperature. In these situations, the unpacking process may be carried out at a high temperature, above the caking temperature. At high temperatures, the object may not be fully crystallised, and so there may be a risk of breaking the object when unpacking.

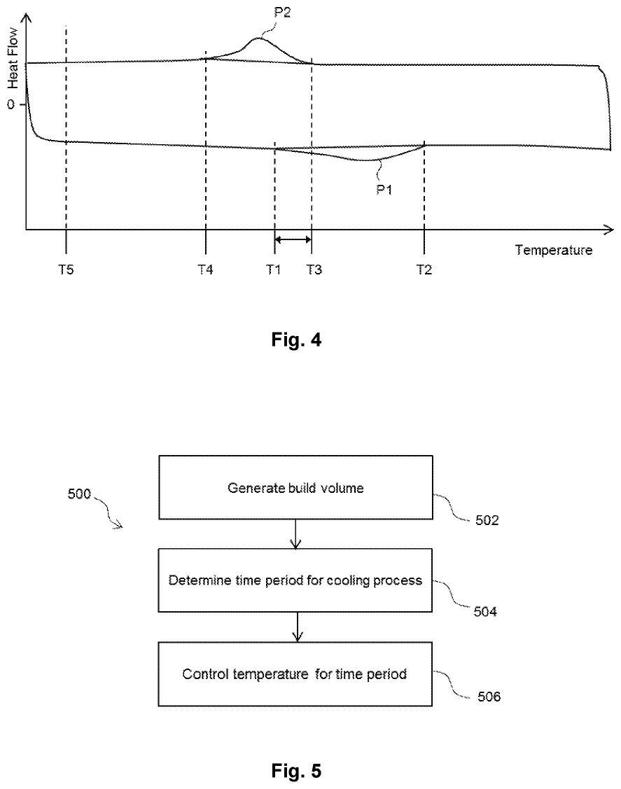

FIG. 4 shows a schematic graphical representation of results of a differential scanning calorimetry experiment of an elastomeric build material. As shown in FIG. 4, as the elastomeric is heated to temperature T1, the material begins to melt. In an example elastomeric build material, the start melt temperature T1 may be approximately 112° C. The material has a relatively wide melting peak P1, compared to other build materials such as polyamides. In the example elastomeric build material, the end melt temperature T2 is approximately 153° C. After the material has been fully melted, when it is heated to a temperature above the end melting temperature T2, the material is cooled. At temperature T3, the material begins to crystallise. In the example elastomeric build material, the start crystallisation temperature T3 is approximately 122° C. The material has a relatively wide crystallisation peak P2, with the end crystallisation temperature T4 being approximately 94° C.

The start crystallisation temperature T3 is greater than the start melt temperature T1, and so the crystallisation peak P2 overlaps with the melting peak P1. This provides a temperature window indicated by arrow C wherein the build material is in both melted and crystallised states. The build unit may be configured to cool the generated object to a temperature close to the end crystallisation temperature T4, or lower, such that a proportion of the object that is crystallised is equal to or greater than a predetermined threshold value.

The caking temperature T5 is also shown in FIG. 4. Any unfused build material that may have exceeded the start melting temperature but did not melt may form cake at the caking temperature T5. In the example elastomeric build material, the caking temperature is approximately 60° C. The build unit 100 may be configured to cool the generated object below the end crystallisation temperature T4, and above the caking temperature T5, so that the object may be unpacked before the build volume cools to the caking temperature and cake is formed

The printing system 10 may comprise a controller 400. The controller may be configured to determine the temperature at which the heaters 108, 110 in the build volume should be controlled, to heat the build chamber 102. The controller 400 may be configured to determine a time period for the cooling process. The time period may be determined to be the minimum time required to cool the generated object such that a proportion of the object that is crystallised is equal to or greater than a predetermined threshold value.

The portion of the object that is crystallised may impact the risk of breakage of the object during unpacking. For example, when the portion of the object that is crystallised is 50%, the risk of an operator breaking an object during unpacking may be much higher than when 80% of the object is crystallised. The threshold value may be approximately 80%. In another example, the threshold value may be approximately 85%. In another example, the threshold value may be approximately 90%.

Table 1 shows crystallisation proportions for the example elastomeric build material, when the build material is at various temperatures. At 126° C., the build material is above the end melt temperature, T2, and so the percentage of build material that is crystallised is 0. As the temperature of the build material is decreased below the start crystallisation temperature T3, the proportion of the crystallisation increases. At 95° C., which is close to the end crystallisation temperature T5, the proportion of the build material that is crystallised is approximately 81%. The generated object may therefore be unpacked when the temperature of the object is above the end crystallisation temperature T4, if a sufficient proportion of the object is crystallised.

TABLE 1

| T (° C.) | Crystallization ratio (%) |
|---|---|
| 126 | 0 |
| 105 | 27.90 |
| 100 | 57.19 |
| 95 | 81.20 |

The portion of the object that is crystallised when the unpacking takes place may also affect the number of human operators that carry out the unpacking. For example, when the crystallisation proportion is at least 80%, one operator may be able to unpack the object, instead of two, thereby reducing the total cost per generated object.

The controller may be configured to determine a temperature at which the heaters may heat the build unit during the cooling process, and may control the heaters to be heated to this temperature. The temperature may be determined according to start and end crystallisation temperatures T3, T4 of the build material.

The controller may be configured to determine the temperature at which the heaters may heat the build unit during the cooling process according to the caking temperature T5 of the build material.

The temperature at which the heaters may heat the build unit during the cooling process may be constant throughout the cooling process. In other examples, a temperature profile may be applied, in which the temperature at which the heaters heat the build unit during the cooling process may vary during the cooling process.

In a natural cooling process, the build volume is cooled naturally, without any cooling mechanism. However, in natural cooling, the cooling rate may be too high, with portions of the build material reaching the caking temperature within a short period of time. For example, the elastomeric build material can reach a temperature of below the caking temperature, 60° C., within only two hours. This may result in the build volume being discarded, because the printed object may not be removable from the build volume. Applying heat to the build unit during the cooling process may slow down the cooling rate, to prevent the build material reaching the caking temperature. The cooling process may therefore slow down the rate of cooling relative to a natural cooling process.

The controller 400 may be configured to determine the time period of the cooling process according to a dimension of the generated object, for example a height of the generated object. The controller may be configured to receive print job information, for example from the printer 300, wherein the print job information may include the height of the object. The temperature of the object may vary across the height of the object, during the cooling process. This may be due to the time taken to generate the object, wherein the upper layers are generated some time after the lower layers, giving the lower layers time to begin cooling before the print job is completed.

The controller may be configured to determine the time period of the cooling process according to a width of the generated object. If the generated object is wider, portions of the generated object may be closer to the heaters provided on the side walls of the build unit relative to a narrower object. The time period may be longer for narrower objects than wider objects. The print job information may include the width of the object.

The controller may be configured to determine the time period of the cooling process according to a wall thickness of the generated object. The print job information may include information regarding a wall thickness of the generated object. An object with a thicker wall may cool more slowly than an object with a thinner wall, and so the time period may be longer for objects with a greater wall thickness than objects with a smaller wall thickness.

The build volume may comprise a plurality of generated objects. The time period for the cooling process may be determined according to the distribution of generated objects within the build volume. The time period for the cooling process may be determined according to the density of generated objects in the build volume. The received print job information may include density information and/or spatial distribution information of the generated objects within the build volume.

Cooling the build volume for the predetermined time period may prevent the material from being unpacked too early, when the object is not sufficiently crystallised. Cooling the build volume while controlling the temperature of the build unit may prevent cake forming in the build volume.

After the build volume has been cooled for the predetermined time period, the build unit 100 may be removed from the three-dimensional printer 200 and may be moved to the processing station 300. A manual operator may unpack the generated object at the processing station, and the processing station 300 may be configured to collect the unfused build material, for example for recycling.

FIG. 5 shows a flowchart of an example method. The method may be executable by the three-dimensional printing system shown in FIG. 1.

The method comprises, in block 502, generating a build volume comprising a three-dimensional object provided within build material. The build volume is generated by providing a layer of powdered build material, applying a print agent to a portion of the powered material and heating the layer of powdered material to cause the portion of the build material to which the printing agent is applied to coalesce. A subsequent layer of build material may then be provided on top of the previous layer, and the process may be repeated until the print job is completed and the build volume is generated.

The method may comprise, in block 504, determining a time period for a cooling process of the build volume. The time period may be determined according to at least one of a height of the object, a density of objects within the build volume and a distribution of objects within the build volume. The time period may be determined according to a temperature of heaters that may heat the build unit during the cooling process.

The method comprises, in block 506, controlling a temperature of the build unit for the determined time period such that after the time period, the proportion of the object that is crystallised is greater than a threshold value.

Table 2 shows a comparison of various properties of the generated object of the example build material when the object is unpacked immediately after the object has been generated (hot unpack) and when the build volume has been cooled for 8 and 16 hours with the heaters heated to a temperature of 85° C. before unpacking. As shown in Table 2, the yield is increased by 10% when the build volume is cooled for 8 hours compared to the hot unpack, with only a small extra cost of operation. The elongation at break (a measurement of elasticity) remains approximately constant across the three processes, and the tensile strength and tear resistance increase when the cooling process is implemented. Therefore, the cooling process may not only reduce the risk of an operator breaking the object during unpacking, but may also improve tensile strength and tear resistance of the generated object.

TABLE 2

| | | Cooling for 8 | Cooling for 16 |
|---|---|---|---|
| | Hot unpack | hours at 85° C. | hours at 85° C. |
| Yield | 80% | 90% | — |
| Total cost per | 7.77 | 8.37 | — |
| operation | | | |
| Elongation at break | 154.1 ± 19.4 | 140.9 ± 19.0 | 157.4 ± 16.3 |
| Tensile strength | 8.3 ± 0.2 | 8.9 ± 0.4 | 9.2 ± 0.4 |
| Tear resistance | 41.9 ± 5.4 | 44.7 ± 4.9 | 52.0 ± 4.1 |

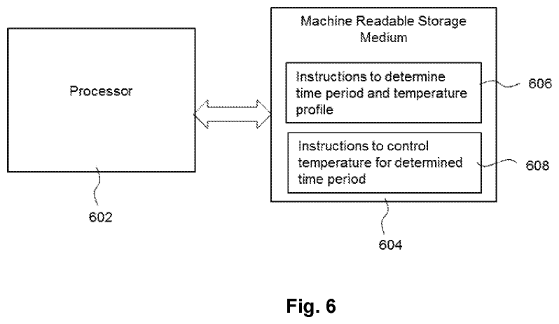

Various elements and features of the methods described herein may be implemented through execution of machine-readable instructions by a processor. FIG. 6 shows a processing system comprising a processor 602 in association with a non-transitory machine-readable storage medium 604. The machine-readable storage medium may be a tangible storage medium, such as a removable storage unit or a hard disk installed in a hard disk drive. The machine-readable storage medium comprises instructions at box 606 to determine a time period for a cooling process after which a predetermined proportion of an object generated by a three-dimensional printing process is crystallised, and a temperature profile for the cooling process. The instructions to determine the time period may comprise instructions to determine the time period according to at least one of a dimension of a generated object, a distribution of a plurality of generated objects in a build unit, and a density of a plurality of generated objects in a build unit and a temperature of the environment.

The machine-readable storage medium comprises instructions at box 608 to control a temperature of the build unit for the determined time period according to the temperature profile. The instructions to control the temperature of the build unit may comprise instructions to control one or more heaters in the build unit to be heated to a temperature according to the temperature profile.

According to examples described herein, a build volume may be cooled for a predetermined time period so that a proportion of crystallisation of the object is equal to or greater than a threshold value. This may reduce the risk of the object breaking during unpacking. The build volume may be cooled at a rate that prevents cake formation, thereby reducing the chance that a generated object may be discarded due to cake formation.

1. A method comprising:
generating a build volume comprising a three-dimensional object by forming a plurality of successive layers, wherein each layer is formed by providing a layer of build material, applying a printing agent to a portion of the build material, and heating the layer of build material to cause the portion of the build material to which the printing agent is applied to coalesce;
after generating the object, cooling the build volume by controlling a temperature of a build unit housing the build volume for a predetermined time period to allow the object to crystallise,
wherein, after the predetermined time period, a proportion of the object that is crystallised is greater than a threshold value.

2. A method in accordance with the method of claim 1, wherein controlling the temperature comprises controlling the temperature according to a temperature profile over the time period.

3. A method in accordance with the method of claim 1, wherein controlling the temperature of the build unit comprises controlling the temperature of the build volume to be greater than a caking temperature of the build material and lower than a lower limit of a crystallisation temperature range of the build material.

4. A method in accordance with the method of claim 1, wherein the threshold value is at least 80% by weight of the object.

5. A method in accordance with the method of claim 1, comprising determining the time period for which the temperature of the build unit is controlled, wherein determining the time period comprises determining a minimum time for which a proportion of the three-dimensional object is crystallised is equal to or greater than the threshold value.

6. A method in accordance with the method of claim 5, comprising determining the minimum time based on at least one of a height, a width and a wall thickness of the three-dimensional object.

7. A method in accordance with the method of claim 5, wherein generating the object comprises generating a plurality of objects within a build volume and wherein the minimum time is determined based on at least one of a density of the generated objects within the build volume and a spatial distribution of the generated objects within the build volume.

8. A method in accordance with the method of claim 5, wherein determining the minimum time comprises determining the minimum time based on the temperature of the build unit.

9. A method in accordance with the method of claim 1, wherein the build material is an elastomeric material.

10. A three-dimensional printing system comprising a build unit, a three-dimensional printer and a controller, the build unit comprising a build chamber and a heater;
wherein the printer is configured to generate a build volume comprising a three-dimensional object within the build chamber and the heater is configured to heat the build chamber, and
wherein the controller is configured to control the heater to heat the build chamber for a predetermined time period after the build volume is generated, to allow the object to crystallise.

11. A three-dimensional printing system in accordance with the three-dimensional printing system of claim 10, wherein the controller is configured to control the heating device to according to a temperature profile across the predetermined time period.

12. A three-dimensional printing system in accordance with the three-dimensional printing system of claim 10, wherein the controller is configured to control the heating device to maintain a temperature within the build chamber, wherein the temperature is higher than a caking temperature of a powdered build material from which the object is generated, and lower than a crystallisation temperature of the powdered build material.

13. A three-dimensional printing system in accordance with the three-dimensional printing system of claim 10, wherein the controller is configured to determine the time period, such that after the time period, a predetermined portion of the generated object is crystallised, wherein the processor is configured to determine the time period according to a dimension of the generated object.

14. A non-transitory machine-readable storage medium encoded with instructions executable by a processor, the machine-readable storage medium comprises:
instructions to determine a time period for a cooling process after which a predetermined proportion of an object generated by a three-dimensional printing process is crystallised and a temperature profile for the cooling process,
instructions to control a temperature of an environment of the generated object for the determined time period according to the temperature profile.

15. A non-transitory machine-readable storage medium in accordance with claim 14, wherein the instructions to determine the time period comprise instructions to determine the time period according to at least one of a dimension a generated object, a distribution of a plurality of generated objects in a build unit, and a density of a plurality of generated objects in a build unit.
